(19) United States
(12) Patent Application Publication
(10) Pub. No.: US 2006/0017858 A1
(43) Pub. Date: Jan. 26, 2006

(54) Wireless liquid crystal display television

(75) Inventor: Yet-Zen Lin, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 11/119,895

(22) Filed: May 3, 2005

(30) Foreign Application Priority Data
Jul. 21, 2004 (TW) 093211522

(51) Int. Cl. H04N 5/44

(52) U.S. Cl. 348/790; 348/734

(57) ABSTRACT

The present invention relates to a wireless LCD television comprising a remote controller and a host display device. The remote controller receives several display signals of various formats, encodes the several display signals into the same format, and transmits one of the several display signals of the same format based on a switch flag to a remote end. The host display device receives the display signal from the remote controller, decodes the display signal into a decoding signal, and displays a program on an LCD panel in accordance with the decoding signal.

### BACKGROUND OF THE INVENTION

1. Field of the Invention

The present invention relates to a liquid crystal display (LCD) television, and more particularly to a wireless LCD television.

2. Description of Related Art

As shown in FIG. 1, it is generally necessary for either a conventional LCD television 5 or a cathode ray tube (CRT) television to comprise a host device, a power line (for obtaining an external power) and a signal line (for receiving an external display signals) so as to display programs. Due to limitations to the length of the signal line, the conventional LCD television 5 has to be close to the source of the display signals. As such, the position where the host device is placed is limited. The conventional LCD television 5 is characterized by being light-weight and low profile, and has become popular gradually. The user likes to set up the conventional LCD television 5 at an appropriate position such as the center of the wall of the living room to have pleasant audiovisual entertainment. If the signal line disposed around the conventional LCD television 5 appears messy or the conventional LCD television 5 could not placed at a desired place because of limitation of the signal line, it will cause inconvenience to the user. Based on the foregoing disadvantages, it is desirable to provide a wireless LCD television to mitigate and/or obviate the above-mentioned problems.

### SUMMARY OF THE INVENTION

To avoid the aforementioned disadvantages, the present invention discloses a wireless LCD television that comprises a remote controller and a host display device. The remote controller comprises a remote controller for receiving and performing an encoding process on at least one display signal of various formats to output at least one display signal of a default format, and then transmitting one of the display signal of the default format in accordance with a switch signal to a far end. The host display device is disposed on the far end and comprises a wireless receiver for receiving and outputting one of the display signal wirelessly; a decoder for receiving and performing a decode process on the display signal from the wireless receiver and outputting a decoded signal; a LCD panel for displaying in accordance with the decoded signal.

Because the wireless LCD television of the present invention needs no signal line, the position of the wireless LCD television of the present invention shall not be limited by the disposition or the length of the signal line. The remote controller is used for decoding processes for an audio/video display signal, a television display signal or a personal computer display signal, and hence it is not necessary for the LCD television to have a circuit designed for the decoding processes so that the size of the LCD television is reduced and the aforementioned disadvantages are avoided.

Other objects, advantages, and novel features of the invention will become more apparent from the following detailed description when taken in conjunction with the accompanying drawings.

### BRIEF DESCRIPTION OF THE DRAWINGS

FIG. 1 is a front view of a conventional LCD television;

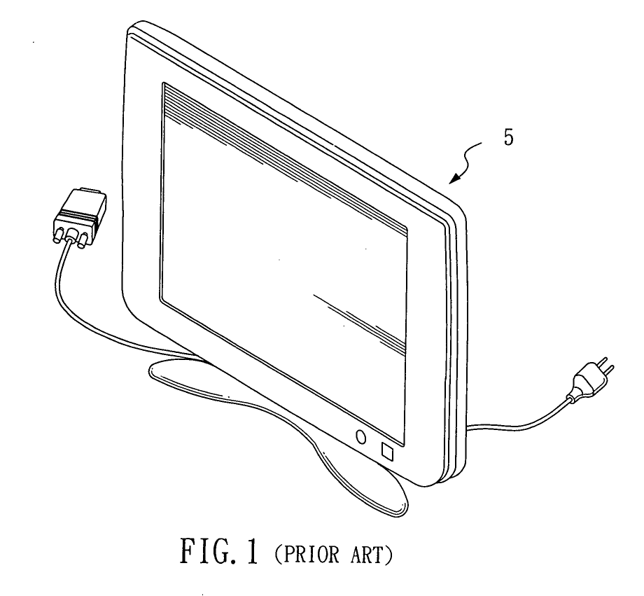

FIG. 2 is a schematic view of a wireless LCD television according to the present invention; and

FIG. 3 is a block diagram of the wireless LCD television according to the present invention.

### DETAILED DESCRIPTION OF THE PREFERRED EMBODIMENT

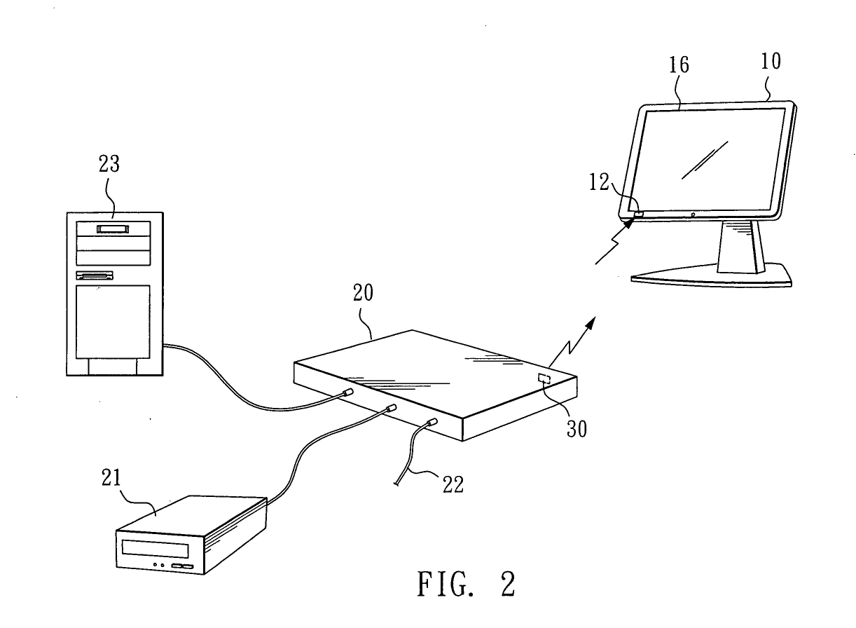

Referring to FIG. 2, a wireless LCD television according to the present invention comprises a host display device 10 and a remote controller 20. The remote controller 20 is adopted to receive and then transmit a display signal to a wireless receiver 12 of the host display device 10 via a wireless transmitter 30. Subsequently, the host display device 10 performs a further process on the display signal and then displays a program on an LCD panel 16. As such, since no signal line is extended from the host display device 10, the position of the host display device 10 will not be limited by any signal line.

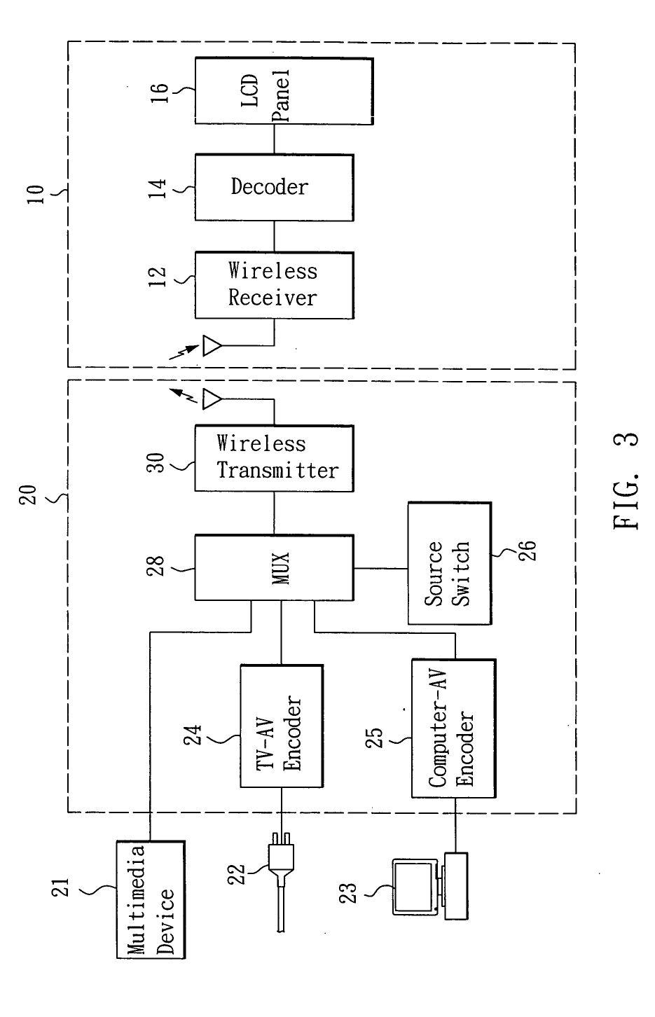

Referring now to FIG. 3, the remote controller 20 is connected to a plurality of signal lines for receiving display signals of various formats. For example, an audio/video signal line is connected to a multimedia device 21 such as a digital versatile disk (DVD) player 21, a video recorder or a home video game machine, to receive an audio/video (AV) display signal; a television signal cable 22 is used to receive a television display signal; and a computer display signal line is connected to a computer device 23, such as a desktop computer, a notebook computer or a portable computer, to receive a computer display signal. An encoder having various coding capabilities is used to transfer the format of the AV display signal, the television display signal or the computer display signal to a default character. For example, all of the aforementioned display signals are subject to a coding process to result in code signals in compliance with the format of the AV display signal. Thus, the television display signal proceeds with a television-AV coding process by a TV-AV encoder 24 to result in a second AV display signal; and the computer display signal proceeds with a computer-AV coding process by a computer-AV encoder 25 to result in a third AV display signal. Consequently, both the second AV code signal and the third AV code signal have the same format in compliance with the AV display signal. In addition, the AV display signal from the multimedia device 21 renames a first AV display signal and needs not to perform the coding process.

A source switch 26 outputs a switch flag to a multiplexer (MUX) 28. The operation of the source switch 26 is preferably controlled by a switch bottom of the remote controller 20 so as to control the switch flag outputted from the source switch 26. The multiplexer 28 receives the first, second and third AV code signals, and then, outputs one of the first, second and third AV code signals in accordance with the switch flag. For example, if the switch flag corresponds to the multimedia device, the multiplexer 28 outputs the first display signal. If the switch flag corresponds to a television, the multiplexer 28 outputs the second display signal. If the switch flag corresponds to a computer, the multiplexer 28 outputs the third display signal.

A wireless transmitter 30 receives the display signal outputted from the multiplexer 28, and then, the code signal is modulated for outputting a modulated signal to be transmitted to the wireless receiver 12 at a remote end. For example, the wireless receiver 30 receives the first display signal outputted from the multiplexer 28, and then, the first display signal is modulated to output a modulated display signal to be transmitted to a remote end; or the wireless receiver 30 receives the second display signal outputted from the multiplexer 28, and then, the second display signal is modulated to output the modulated display signal to be transmitted to a remote end; or the wireless receiver 30 receives the third display signal outputted from the multiplexer 28, and then, the third display signal is modulated to output the modulated display signal to be transmitted to a remote end.

The host display device 10 is positioned far from the remote controller 20, receiving the modulated display signal transmitted from the remoter controller 20 for subsequent processes. The functions of the internal components of the host display device 10 are described hereinafter.

The wireless receiver 12 receives the modulated display signal transmitted, demodulates the modulated display signal to one of the display signals, and outputs the display signal to a decoder 14. For example, the modulated display signal transmitted by the remote controller 20 is received and demodulated to result in the first display signal to be outputted to the decoder 14; or the modulated display signal transmitted by the remote controller 20 is received and demodulated to result in the second display signal to be outputted to the decoder 14; or the modulated display signal transmitted by the remote controller 20 is received and demodulated to result in the third display signal to be outputted to the decoder 14.

The decoder 14 is used to decode the display signal into a decode signal receivable by the LCD panel 16. For example, the decoder 14 decodes one of the first, second and third display signals outputted from the wireless receiver into the decode signal receivable by the LCD panel 16 to the LCD panel 16.

The LCD panel 16 displays a program in accordance with the decode signal outputted from the decoder 14.

Both the wireless transmitter 30 and the wireless receiver 12 are preferable analog communication devices, having advantages of simple construction, low manufacturing cost and real-time transmission of signals. Even so, digital communication devices can be applied to both the wireless transmitter 30 and the wireless receiver 12 to have advantages of reduced interference of noise between signals and omni-directional transmission of data. In the foregoing description, the format of the display signals is preferable to convert to the format of the AV display signal. Even so, the format may be a television display signal format, a computer display signal format, a chromatic difference display signal format or another display signal format in accordance with the user's need.

Because no signal line is connected to the host display device 10, the host display device 10 will not be limited by the disposition or the length of the signal line. Further, processes of encoding or decoding display signals are performed on the remote controller 20 instead of the host display device 10, therefore the size of the host display device 10 is reduced and the purpose of the present invention is attained.

Although the present invention has been explained in relation to its preferred embodiments, it is to be understood that many other possible modifications and variations can be made without departing from the spirit and scope of the invention as hereinafter claimed.

What is claimed is:

1. A wireless liquid crystal display (LCD) television, comprising:
a remote controller for receiving and performing an encoding process on at least one display signal of various formats to output at least one display signal of a default format, and then transmitting one of the display signal of the default format in accordance with a switch signal to a far end; and
a host display device disposed on the far end, comprising:
a wireless receiver for receiving and outputting one of the display signal wirelessly;
a decoder for receiving and performing a decode process on the display signal from the wireless receiver and outputting a decoded signal; and
an LCD panel for displaying in accordance with the decoded signal.

2. The wireless LCD television of claim 1, wherein the remote controller comprises:
an encoder for at least one display signal of different format to at least one display signal of a default format;
a switch for outputting a switch signal;
a multiplexer for receiving the at least one display signal of the default format and outputting one of the display signal of the default format in accordance with the switch signal; and
a wireless transmitter for wirelessly transmitting one of the display signal from the multiplexer to the far end.

3. The wireless LCD television of claim 1, wherein the at least one display signal of different format is obtained from a digital versatile disk (DVD).

4. The wireless LCD television of claim 1, wherein the at least one display signal of different format is obtained from a video recorder.

5. The wireless LCD television of claim 1, wherein the at least one display signal of different format is a television display signal.

6. The wireless LCD television of claim 1, wherein the at least one display signal of different format is a computer display signal.

7. The wireless LCD television of claim 1, wherein the wireless receiver is an analog wireless receiver.

8. The wireless LCD television of claim 1, wherein the wireless receiver is a digital wireless receiver.
